(19) United States
(12) Patent Application Publication
(10) Pub. No.: US 2007/0083415 A1
(43) Pub. Date: Apr. 12, 2007

(54) Computerized internetwork system for automated training, management, and accounting of distributors

(76) Inventors: Ken Forrest, Provo, UT (US); Ken Meads, Salem, UT (US); Rodger Smith, Provo, UT (US); Nathan Best, Cedar Hills, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/545,330

(22) Filed: Oct. 10, 2006

Related U.S. Application Data
(60) Provisional application No. 60/725,557, filed on Oct. 11, 2005.

(51) Int. Cl. G05B 19/418; G06F 15/02; G06F 9/46

(52) U.S. Cl. 705/8; 705/9

(57) ABSTRACT

A computerized method, apparatus, and system for office administration, reporting, commissions, order processing, support for recruiting, training, retention, and website replication, as well as other support functions may be provided over the Internet. Product presentations, lead capture, and other interactions with web visitors may be provided for distributors in a network marketing company, along with preformulated materials and personal contacts from supervisors through a combination of front office servers, back office servers, and field office servers. The system may direct and redirect leads acquired over the Internet throughout an organization based on questionnaires, interests of a contact, and qualifications of distributors by objectively matching contacts as leads to distributors.

### RELATED APPLICATIONS

This application claims priority to U.S. Provisional Patent Application Ser. No. 60/725,557, filed Oct. 11, 2005, and entitled COMPUTERIZED INTERNETWORK SYSTEM FOR AUTOMATED TRAINING, MANAGEMENT, AND ACCOUNTING OF DISTRIBUTORS.

### BACKGROUND

1. The Field of the Invention

This invention relates to computer software, and, more particularly, to business management software performing functions of front office and back office marketing presentations, communications, online training, as well as administrative and bookkeeping functionality.

2. The Background Art

Industry and commerce are directed to creating products and services as well as presenting and distributing those products and services to a marketplace of potential customers and customers. Every company must devote resources to generation of products and services and the marketing and subsequent fulfillment of sales of those products or services. Virtually all companies establish equipment, personnel, training, systems, procedures, forms, reporting, or the like to systematize operations. This makes the operation reliable, repeatable, manageable, reproducible, transferable, sustainable, and so forth. Limits, averages, controls, and the like establish norms for key processes. Thus the business is “normalized.”

To meet the requirements of customer markets, various types of “marketing engines” now exist. Marketing engines may be thought of as mechanisms, whether human, electronic, mechanical, or the like for introducing information, motivating a purchasing decision, and fulfilling the purchase request. Marketing engines may include Internet advertising and sales software, sales personnel forces for face-to-face contact with potential customers, retail store fronts with personnel staffing, direct-contact personnel sales forces, catalog advertising and order taking, network sales forces comprising networks of persons who have preexisting relationships or who develop relationships by which they conduct commerce, and the like.

Each marketing engine may be devoted to a particular industry of potential manufacturers, an industry of potential customers, a geographical or physical location, or possibly a group of people in an organization. Thus, a marketing engine may exist in a cyber world, a physical world, a social world, a geographical world, or the like, that may be thought of us a domain of operation. For each domain of operation in which a company may operate, mechanisms must be relied upon to convey information to potential customers about products and services, to administer transactions to exchange those goods or services for compensation, and a fulfillment mechanism to assure delivery and satisfaction with respect to those goods and services delivered.

Any action or function that requires human intervention typically requires some degree of personnel management. Personnel management may include recruiting, hiring, training, supervision, compensation, and the like. With the advent of the Internet, many functions that were previously quite personnel-intensive have been transferred to software programs in order to expand geographic availability, expand time of availability, improve reliability of information transfer, minimize personnel, or otherwise improve the exchange of information, transaction of business, and fulfillment of orders.

One bastion of intense dependence upon human relationships and activities has been the marketing engine commonly referred to as network marketing. Network marketing has traditionally relied upon relationships previously existing between persons to establish business relationships for sales of product, recruiting of personnel, and other subsequent or related followup. This area of business or this marketing engine has relied upon relationships to make contacts, and must then rely upon the adequate skills of persons in those relationships to advance business purposes. This is inherently problematic.

In any relationship there is typically a hierarchy. Economic status, educational status, intelligence, age, and a host of other factors may tend to skew the relationship. That is, credibility, information, articulation, time availability, courtesy, respect, influence, and the like may all be affected positively or negatively between two individuals, depending upon various status elements that predate any commercial relationship.

Moreover, an individual initiating a commercial relationship based on some other relationship may have anywhere from a slight to an overwhelming base of knowledge, experience, training, or the like to assist in garnering attention and making presentations. Thus, presentation effectiveness varies radically from person to person or from relationship to relationship.

Finally, behind a host of other endemic limitations to be overcome in network marketing, the contacts one individual has are basically limited by previous experience and exposure to other persons. The law of averages, meanwhile, limits the number of successful closes or transitions of relationships from social (e.g. family, friend, acquaintance, co-worker, etc.) or otherwise into commercial relationships (e.g. buyer, seller, recruit, trainee, etc.).

In the world of software for supporting commerce generally and businesses specifically, recordkeeping has been historic. Some of the earliest applications of computer programming have been to the recording, analysis, maintenance, and reporting of business records. Tasks like accounting have long been recognized as appropriate fields for obtaining substantial benefits from automation through computer systems. More recently, the Internet has become a grand web for distributing information by numerous mechanisms in order that the information may be found by those seeking it or searching for it.

With such an ingrained dependence on person-to-person contact, typically in a personal and often face-to-face context, network marketing seems a poor candidate for systems, Internet software, and applications to automate most aspects of its operations. What is lacking and sorely needed in network marketing is a mechanism to normalize the typical operations required. That is, it would be an advance in the art to standardize or systematize the contacting, product presentation, company presentation, training, communication, motivation, and the like across the world and from person to person. This should occur in such a way that a particular potential customer or potential recruit could receive substantially the same information in a substantially uniformly credible way that it could be accurately and completely received with an open mind, fair evaluation, over a reasonable time, with a minimum of bias, prejudice, or unreasoning resistance, regardless of the person who first introduces that potential customer or recruit to the company or product in question.

What is needed is a system and method for introducing uniformity, and providing tools to individuals involved in network marketing organizations. Tools needed include mechanisms for generating contacts over the Internet, mechanisms for uniformity of followup using experience of others who have more experience, integration of data analysis of what mechanisms are effective in order to select mechanisms to be applied to any aspect of marketing and recruiting, and a mechanism for uniformity of training. Likewise needed are a mechanism for organizing and docketing contacts and followup, a mechanism for evaluating contacts to determine topics and features of most interest, a mechanism and system for qualifying personnel in order to assure appropriate levels of competence for the tasks undertaken, and a mechanism qualifying leads for product or personnel and matching presentations and presenters accurately thereto. These and many other functions could benefit from a system and mechanism for computerization and Internet delivery or support.

Personnel involved in network marketing organizations need information, communication, supervision, training, motivation, testing, feedback, and many other supporting services. Such support would be supplied as a matter of routine to an individual in a captive retail sales force at a location of a retail establishment. However, the nature of network marketing may put large geographical distances between personnel, and minimize actual face-to-face contact between disparate levels in an organization.

Moreover, the time required for communication, training, motivation, and the like in order to recruit, train, manage, retain, and so forth personnel in a network marketing context may be overwhelming with respect to the actual profitability of a particular individual in the network. Thus, a cost effective mechanism is needed to provide through computer networks, such as the Internet, the proper services and support for a network marketing organization to sell product, recruit personnel, train, motivate, and communicate regularly and effectively, and otherwise administer the functions of the network marketing organization.

What is needed is a system and method for providing electronically the remedies for the foregoing lacks. What is needed is such a remedy for individuals in a network marketing organization, previously dependent on a very unreliable chain of human contacts, any link of which may destroy the effectiveness thereof.

### SUMMARY OF THE INVENTION

In accordance with the needs for network marketing support in computer systems, Internet delivery mechanisms, and other technologies, an apparatus and method in accordance with the invention provide many features and benefits. A network marketing system may be considered from the viewpoint of the corporation that produces products and materials for sustaining a network marketing force.

Likewise, the system may be viewed from the perspective of an individual distributor within the ranks of the sales force thereof. Likewise, a network marketing system may be viewed from the perspective of a prospective customer or prospective recruit. Each perspective is unique. From the corporate point of view, a fundamental interest exists in producing product and marketing product. These cause the necessity of recruiting, training, motivating, maintaining, communicating with, and otherwise developing and monitoring, the network of distributors who are of paramount importance.

In a microcosm of the corporation, an individual distributor maintains many of the same priorities. However, distributors may have a propensity toward either sale of product or building an organization of other distributors. Literally, some individuals may be most interested in marketing product, while others may be most interested in managing an organization. Likewise, from the point of view of a prospective customer or prospective recruit, the dichotomy of interest is more pronounced. Some people are interested in products, and are only interested in being purchasers, while others have a decided interest in being sellers, recruiters, or both. People who like a product, and have success in sharing it with others, may eventually become more interested in converting customers to distributors.

However, in an apparatus and method in accordance with the invention, Internet delivery of the tools, materials, and information required by a multilevel marketing company, a network marketing organization, or a network marketing manager, may greatly enhance and “normalize” the effectiveness of each individual and organization in the network marketing structure. In certain embodiments of an apparatus and method in accordance with the invention, a front office website of a corporation or of a distributor selling products provided by the corporation may introduce an individual to a product through a web browser over the Internet.

Following an introduction, the interest may be assessed of that contact or computer user who has contacted the website. The user may select whether or not to pursue an interest in the product or in the business opportunity of the company. Thus, following a decision as to interest, the individual may be presented with navigational aids to assist in navigating the website, followed by a tour appropriate to the level of interest and direction of interest.

For example, an interest in the product may lead to a product tour. Alternatively, some persons prefer to navigate in their own direction and at their own speed through an index and would be more interested in presentation of a catalog directly. Thus, a user may take a guided tour, in which audiovisual presentations and text information as well as graphics and other presentation mechanisms may provide a logical flow of information. By the same token, a suitably indexed catalog may provide information for a person more determined to obtain specifics of most interest.

A tracking system may track both the navigation of a user through a tour or catalog, as well as any possible interactions. For example, as decisions are made and information is presented, the resulting profiling may be saved by the website.

Similarly, navigation of the company branch of the presentation on a website may provide company navigation aids to a user. In accordance with the navigation aids, one may choose a tour of the company information by a suitable audiovisual presentation of information. Instead, one may elect to navigate individually a brochure containing equivalent information in a more unstructured format as to sequence. Either may be well indexed for navigation by tables of contents and the like.

Similarly, tracking of decisions, navigational sequences, and pages, and interactions may be conducted by the website. Moreover, at an appropriate time, a user may be presented gifts, invitations to inquire further, opportunities to be compensated for responding to questionnaires, and the like. Thus, the level of interaction may be substantial, and the information gathered may likewise be significant.

Ultimately, a visit to a website will result in one of three options. Of course, the option to go back or to exit a website is always available. Nevertheless, to any user who does not check out of a website, three options are available. One may purchase products, one may request new information or more information, or one may enroll as a distributor for the company or for the host of the website.

All information provided on a website by a user may be analyzed to qualify that person as a member of the public having access to the website, having made decisions, and then having disappeared. Likewise, that person may be qualified as a potential or actual customer of product. Likewise, that individual may be characterized with respect to any potential interest in becoming a distributor. Also, anyone who has made no decisions to interact with the company other than to ask for information may be qualified as a potential customer or distributor.

Several other needs exist besides making contacts over the Internet. Making contacts over the Internet permits a uniformity of presentation of product and company information. Many other abilities that are normally permitted only in face-to-face meetings in networking marketing may actually be augmented or delivered over the Internet.

For example, planning communications or activities may improve distribution of distributors in a “downline” of persons reporting to a manager with whom they have a relationship. Currently, such actions are very dependent upon the activities and skills of an individual manager. However, automatic reordering of product by distributors may be recorded in a database. Likewise, subjective commitments by a dealer (distributor) in terms of plans, hours of work, commitments to goals, and available time, may all be used to formulate a projection of potential sales.

Likewise, both plans and commitments may be weighted according to historical accuracy with objective hard data as well as subjective evaluations by persons reporting to a particular individual. Likewise, persons to whom an individual reports may also permit or provide subjective opinions to be used as the historical basis for weighting the likely outcome of subjective commitments made by an individual. That is, ultimately, an analysis may be conducted to evaluate what the sales projections are for a particular individual. These may be based on historical reality, subjective commitments, automatically known data from reorders, historical performance, or any combination thereof.

Thus, an analysis may provide a report and recommendations to a manager for interacting with a particular individual for whom that manager is responsible. Data is ever present for the individuals in a network marketing organization. That data may be analyzed in order to highlight activities, weaknesses, needs for training, beneficial communications, motivational factors, and the like that may be effective for that individual. Moreover, over time, statistical analysis may be done to correlate substantially any characteristic of an individual in order to determine the effect of any activity.

For example, one may analyze data for distributors in terms of their calendar age, their time within a program, their past sales history, their product types, and the like in order to determine how well that person sells under what sets of conditions. Likewise, the response to individual training, individual time spent, frequency of communication, the actual communication content, or various motivational activities or features, may all be correlated to that individual. Thus, a system and method in accordance with the invention can analyze the effect of various activities on the performance of individuals having certain characteristics.

Therefore, a plan or schedule may be assembled by a computer that will propose particular communications, particular training, particular motivational items and activities, and particular personal contacts that may help an individual. Morever, the plan or schedule provided by the computer system may provide a specific sequence, timing, periodicity, or the like for any of these interventions by management.

Accordingly, a docket may be provided that will identify what communications, what trainings, what motivations, what personal contacts, and what monitoring need to be conducted by a manager and a specific schedule for same in order to best assist a particular distributor.

In one embodiment of an apparatus and method in accordance with the invention, front office information provided by a corporate website or an individual distributor's website to the public may provide an interactive query to a user. Accordingly, responses may come as a result of queries, such as navigational helps in navigating the website, questionnaires, selections, queries to narrow selections, and the like. Each may be used to determine numerous features of interest and qualification of a website visitor.

Accordingly, analysis of such data may provide an output qualifying a contact in terms of skills, interests, time commitments, product interest, and motivations for becoming a distributor. Likewise, factors such as age and other experience may tell something of sophistication. Previous experience in network marketing may also tell many things about a website visitor.

An appropriate matching may be made with a visitor to direct that visitor's lead information to a particular manager. For example, a brand new distributor having almost no product experience, no training, and very little time in the position of a distributor, would be ill equipped to deal with a contact who has spent fifteen years in another network marketing company with products of the same type being offered by a particular website. Thus, that lead should possibly be handled by a manager over the distributor whose website actually obtained the lead.

Thus, a system may be implemented for automatically intervening. Intervention may be selected by a website host computer, or by an individual decision made by a website host person. After review of the information, a manager may personally redirect a contact. The contact may go to a most suitable person in an “upline” or a “downline” who can handle that lead effectively.

Thus, a method and apparatus in accordance with the invention may rely on various servers to provide conventional back office administrative support for a sales organization in terms of genealogies, volumes, commissions, reporting, shipping, bookkeeping, inventory, and the like. At the same time, an augmented back office system may provide additional assistance in recruiting, training, retention, and the like for a distributor recruiting other distributors. Likewise, a corporate, management, or other replicated website may normalize the actual ability of a individual distributor to provide information on products or on the company and its sales opportunities.

Meanwhile, the “front office” may be hosted by the corporate website, an individual distributor's website, or may be replicated at will by distributors in order to present the product tour, a product catalog, or the like. Likewise, the same website may provide a company tour, company brochure, or the like. Meanwhile, all of these systems may provide a uniformity of content, professional presentations. Thus, each such site could have similar or identical, easily navigable selections and transitions between sources and types of information in order to seamlessly present information.

Another major advantage here with an apparatus and method in accordance with the invention is the escape from the time and personal relationship pressures that may otherwise occur in a face-to-face situation. For example, individual resistance to Internet information is substantially lower than information being pushed by an individual in a face-to-face meeting. One is at liberty to escape an Internet presentation at any moment.

Likewise, people may access the Internet in their homes at a time when they are relaxed and not pressured by other activities. By contrast, during a normal workday, or during the time outside of work, many people have so many commitments to work, family, organizations, volunteer service, and the like, that the time available to actually listen to a complete presentation and come to a point of decision is simply not available.

Thus, in a method and apparatus in accordance with the invention, individuals may access the Internet, review information at their leisure, and be more open-minded about the information they are receiving as they pull it from the Internet, rather than having it pushed at them from an individual. Thus, both the available time and the lack of resistance greatly enhance both recruiting and sales over conventional network marketing, through an apparatus and method in accordance with the invention.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a computer network with routers, servers, and individual nodes suitable for implementing an apparatus and method in accordance with the invention;

FIG. 2 is a schematic block diagram of one embodiment of a fully integrated data support and analysis system in accordance with the invention;

FIG. 3 is a schematic block diagram of an alternative embodiment in which the back office server and the augmented back office server or field office server are not integrated, directly, but may be integrated by an additional interface to render the distinction transparent to a user;

FIG. 4 is a schematic block diagram of yet another alternative embodiment in which a back office and augmented back office may be accessed directly by a single user, although not integrated, as one implementation of the invention;

FIG. 5 is a schematic block diagram of one embodiment of an architecture for the relationship of a front office module and a distributor back office module with a database;

FIG. 6 is a schematic block diagram of one embodiment of a presentation engine for a front office module, and the interaction thereof with the database;

FIG. 7 is a schematic block diagram of a distributor table suitable for implementing records in a database in accordance with the invention;

FIG. 8 is a schematic block diagram of an object-oriented record system for information in a database for supporting a network marketing support system in accordance with the invention;

FIG. 9 is a schematic block diagram of one embodiment of a process for generating and qualifying leads for website visitors over the Internet;

FIG. 10 is a schematic block diagram of one embodiment of a lead management system in accordance with the invention;

FIG. 11 is a schematic block diagram of one embodiment of a process for distributor development over the Internet by deliver of materials and services in accordance with the invention;

FIG. 12 is a schematic block diagram of one embodiment of a sales management process architecture for a website delivery of analysis and planning tools for sales management organizations in a network marketing structure; and

FIG. 13 is a schematic block diagram of one embodiment of a software architecture for a front office website of a company in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations and applied to all types of marketing, although network marketing is used as an example. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

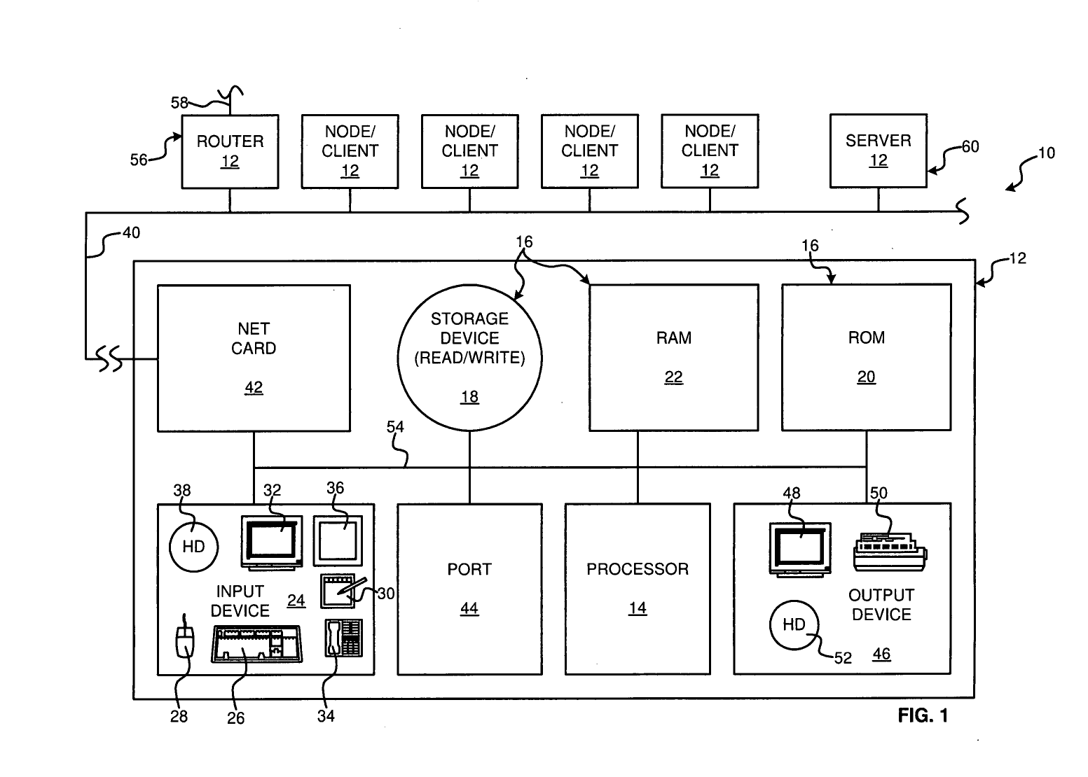

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, or wireless electromagnetic communications by visible light, infrared, or radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 12 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

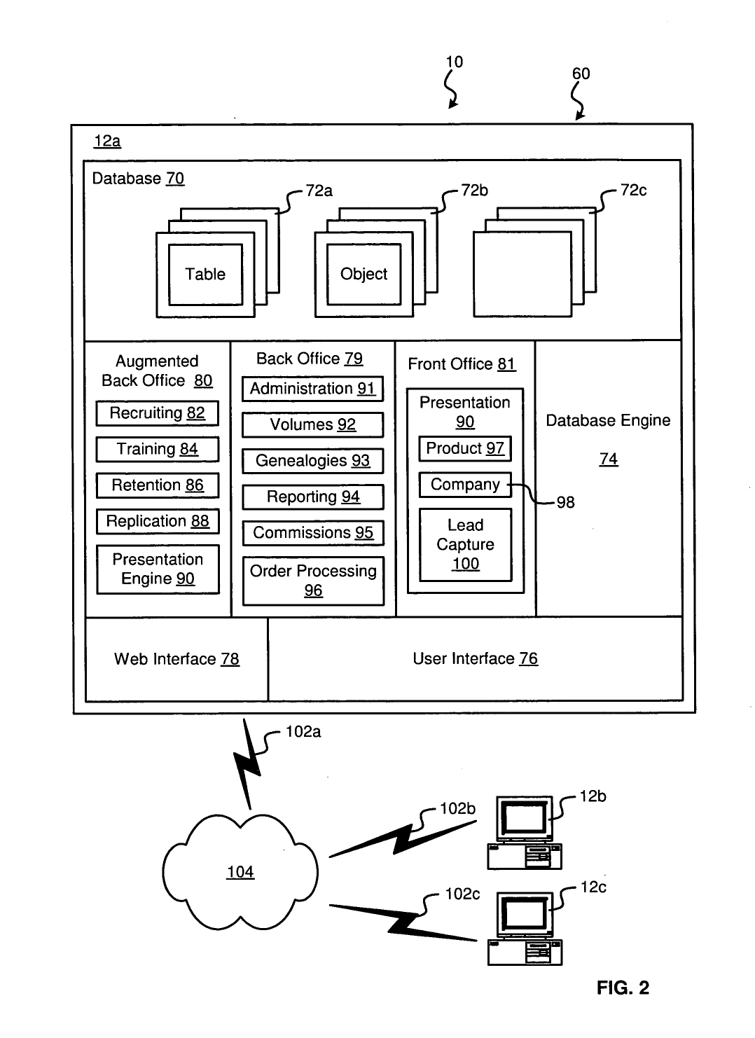

Referring to FIG. 2, a system 10 in accordance with the invention may be described generically, and also in specific embodiments. Hereafter, trailing alphabetical designations following reference numerals refer to specific embodiments, or example embodiments of the generic item identified by the reference numeral. Thus, for example, a node 12 representative of a processor 14 having memory 16, as described hereinabove, may include in memory 16, or loaded into the processor 14 for execution, any of the modules described hereinafter.

Information may be contained in “operational data” that is operated on by “executables” operating on a processor 14. Of course, an executable may also be referred to as “executable data” that can be loaded into a processor 14 in order to cause some function to happen. Executable data or executables are simply the programming instructions, logic, applications, or the like that program a processor to fetch, decode, and ultimately execute machine instructions. By contrast, operational data is that data representing only information. Numbers, facts, characters, images, and the like may all be processed by a processor 14 operating under the instructions contained in executables.

Referring to FIG. 2, a database 70 may be loaded into a node 12 that may be configured as an individual peer-to-peer arrangement, a server 60, or the like. The database 70 may maintain records 72 in any of a variety of formats. Object-oriented programming, tables, and the like, are all suitable mechanisms for maintaining records 72 in a database 70. A database engine 74 may operate to interact between outside applications or programming logic and the database 70. Accordingly, a database engine 74, typically may be responsible to retrieve information from the database records 72, and place information into those records 72, according to the programming.

A system 10 in accordance with the invention may include a user interface 76 for interacting with an individual user. The user interface 76 may be programmed on a user's computer, or may simply be an interface 76 for interacting with the browser on a workstation 12b of an individual user accessing the system 10 over the Internet 104 through a suitable connection 102.

Accordingly, a web interface 78 may provide capacity for the system 10 to communicate over the Internet 104. Various applications may be hosted on any individual node 12a or computer 12a. That is, in general, a computer 12 uses applications (programs) made up of various logical flows of executables. In one embodiment of an apparatus and method in accordance with the invention, the node 12a may contain or otherwise host a module 79. The module 79 may be thought of as a back office module 79. The back office module 79 is responsible for maintaining and generating the business records associated with administering the relationships between distributors for a company and the company.

Likewise, the system 10 may include a node 12a storing and operating a module 80. The module 80 may be thought of as an augmented back office module 80 or a field office module 80. That is, in addition to the back office module 79 and its functions, an apparatus in accordance with the invention may include several additional features directed more to the personnel in the distributor network of a network marketing organization, rather than strictly to actual sales, support of financial calculations, and other manipulations.

Likewise, the system 10 may include a node 12a that hosts or otherwise provides a front office module 81. The back office module 79, field office module 80, and front office module 81 may actually be hosted on different computers, may be set up as different servers on the same computer, and may be arranged in a variety of configurations. Nevertheless, in the illustrated embodiment, a system 10 may include each of the modules 79, 80, 81 in order to support the various needs for information exchange, to support delivery of product, training, and reporting, and the collection of data, feedback, and other evaluative materials.

In one embodiment, the field office module 80 or augmented back office module 80 may include a recruiting module 82 responsible for managing recruiting operations, including delivery of recruiting information, analyses, processing of leads, and other functionality. The recruiting module 82 may also provide recruiting materials, presentations, management, data collection, recordkeeping, and the like for a distributor. Similarly, the augmented back office module 80 operating on a computer of a corporation, may manage such functionality on behalf of the corporation. Similarly, a node 12a hosted by an individual distributor, or manager, may contain such information needed for the management of the downline of the host of that node 12a.

Likewise, a training module 83 may provide for delivery of training information and materials, as well as reporting, management, and other functionalities described. Scheduling, analysis, materials matching to situations and individuals, and the like may all be provided by the training module 84. Similarly, the training module 84 may provide a uniform system of training through multimedia presentations, easily accessible and distributable by a manager in an organization. Similarly, the training module 84 may provide such materials for delivery by that manager to others.

A retention module 86 may support many functions, most of which are related to communication, motivation, and the like with respect to personnel in an organization. One of the benefits of the recruiting module 82, training module 84, and retention module 86 is that a certain consistency, normalization, or repeatability is achieved by having high quality materials for presentation of information, tracking of progress, and feedback of progress. This provides more uniformity that is less dependent on the specific skills, or lack thereof, of an individual participant (e.g. distributor, manager, etc.) in a network marketing organization.

A replication module 88 maybe responsible for replicating individual materials, even including an entire website, for delivery to individuals responsible to a manager. Likewise, one may think of that delivery as being made to individual distributors for whom a particular manager is responsible. Thus, the replication module 88 is responsible for the tasks of packaging and delivering, according to the desires and commands of a manager, the necessary information for supporting a distributor in a downline. It may deliver or operate the applications to recruit, train, and retain personnel responsible to that individual.

The presentation module 90 or presentation engine 90 may be configured in a number of ways. For convenience, one may think of the presentation engine 90 as being a part of the field office module 80. Nevertheless, the presentation engine 90 may actually be placed in any number of other locations.

In one embodiment, the presentation engine 90 may actually provide a front end, or a front office 81 presentation on behalf of a distributor hosting a website 12a. Alternatively, the presentation engine 90 may simply be the engine that provides access to presentations and delivery of the information, along with management thereof, in order to support presentations by a distributor hosting the website associated with the node 12a. As a practical matter, a presentation engine 90 is sometimes thought of as the supporting logic or programming responsible to deliver any of the materials in the modules 82, 84, 86.

Such information may typically be thought of as pertaining primarily to people within an organization, while the front office 81 is typically thought of as presenting similar information, but related more to the front office functionality of dealing with people who are not part of an organization. Thus, for clarity, one may think of the presentation engine 90 in the field office module 80 as pertaining to the presentation of material by a distributor, to a downline distributor, whereas the presentation module 90 within the front office module 81 may be thought of as the presentation engine 90 for presenting information to prospects not part of the organization.

The administration module 91 may include many of the functionalities required for the proper care and feeding of a business organization by way of collecting, analyzing, requesting, and reporting information. Thus, the administration module 91 may be thought of as including many necessary business functions not necessarily unique to a network marketing organization.

By contrast, the volumes module 92 is responsible for managing the information corresponding to the volumes of sales of individuals in a marketing organization. Likewise, the genealogies module 93 is responsible for maintaining the information relating distributors to one another within their reporting relationships. Likewise, the reporting module 94 is responsible for providing standardized reports up and down the distribution chain in order to provide information according to its accumulation and analysis as needed for maintaining the health of the marketing organization.

A commissions module 95 is responsible for calculating distributions of commissions of individual distributors with respect to the sales volumes in the volumes module 92, and the genealogies maintained by the genealogies module 93. Thus, whereas the reporting module 94 may be thought of as being responsible primarily for information, the commissions module 95 is directed more to the functionality of dividing the money from sales in order to provide the commissions to the individuals within a network marketing organization.

The order processing module 96 may be thought of as another similar to the administration module 91. That is, a tremendous amount of information, must be managed by a computer in any organization that ships products. Accordingly, maintenance of inventories at a factory, or those of a distributor, as well as projecting sales and deliveries, and handling the details of fulfillment, must be conducted in any organization that takes orders, collects money, and ships products.

Accordingly, an order processing module 86 operating in a computer or server of a home office (e.g. corporate headquarters, etc.) of a network marketing organization may maintain the records necessary for processing orders from its factory. Similarly, to the extent that a network marketing organization may actually permit or operate with distributors actually maintaining inventory, an order processing module 86 may exist in the back office 79 of an individual distributor.

However, as a practical matter, the back office module 79 may be thought of as existing typically at a headquarters of a company or branch of a company, and being accessed over the Internet 104 by an individual distributor or by the software that manages the information for that distributor.

The front office module 81 may include various functionalities, including a presentation module 90. The presentation module 90 may provide a product module 97 for demonstrating, informing, inviting, and otherwise relating products and prospects. Accordingly, the product module 97 may be responsible primarily for presenting information to prospects (e.g. prospective buyers) while collecting information from the prospective buyer related to interest, navigation toward product lines or specific products of interest, and the like.

Likewise, the product or products module 97 may make inquiries or process feedback. For example, as an individual navigates a website, the selections made are themselves responses to queries. Every selection from a list is a selection of an individual choice over the possible selection of every other item in the list.

Similarly, the company module 98 may be responsible to provide company information, and collect company-related information from a prospect. Typically, one significant distinction between a product module 97 and a company module 98 is that the product module 97 relates to product information, and sales of products. By contrast, the company module 98 typically relates to the company marketing structure and compensation programs for the persons operating as distributors for the company. Accordingly, the company module 98 may be thought of as the sales model module 98 or the sales program 98.

A lead capture module 100 is a valuable executable in many ways. The architecture for the lead capture module 100 may be made in various configurations. Nevertheless, as a practical matter, in association with a presentation module 90, a lead capture module 100 logically works within or in a coordinated effort with a product module 97 and company module 98 to collect and analyze information corresponding to a prospect.

So long as a prospect remains anonymous, the information is simply statistical data relative to visitors to a website. On the other hand, to the extent that an individual asks for additional information, a lead may be identified by a name or other demographic or geographic identifiers that can be more useful. Likewise, an anonymous name, and an anonymous geography, may still provide a known demographic. Accordingly, a lead capture module 100 may provide information on anything related to interest in products, the company, or the like by an individual visitor.

To the extent that a visitor is willing to respond to overt queries, particular demographic or personal information may be voluntarily and affirmatively provided in order to better match the interests of the visitor (e.g. web user, etc.) to the company's offerings. Whether located entirely and directly within the presentation module 90 or elsewhere, the lead capture module 100 may also be responsible to provide analysis of information collected. That is, a lead may be analyzed in order to characterize that lead according to classifications of more interest to the company or to a distributor sponsoring a visited website.

For example, which products, or which program features out of the company's distributor program, are most appealing may qualify the visitor. Likewise, the visiting individual's experience, demographics, or other factors may also characterize a visitor. Accordingly, the lead capture module 100 may analyze data collected during execution of presentations to the visitor, in such a way as to permit qualification of the lead in order to better service an effective response to that lead.

In summary then, an individual user (visitor) on a workstation 12b, 12c may access through a link 102b, 102c the node 12a. In one embodiment, a workstation 12b may be that of a distributor, and the node 12a may be that of someone in the upline or the corporate headquarters of a network marketing company. Likewise, a workstation 12c may pertain to a visitor to the website presented by the node 12a. Thus, a suitable link 102a between the node 12a and the Internet 104 may permit delivery of information to individual distributors, from distributors to the headquarter's company, and from a distributor or the headquarter's company to a particular visitor to a website hosted by a node 12a.

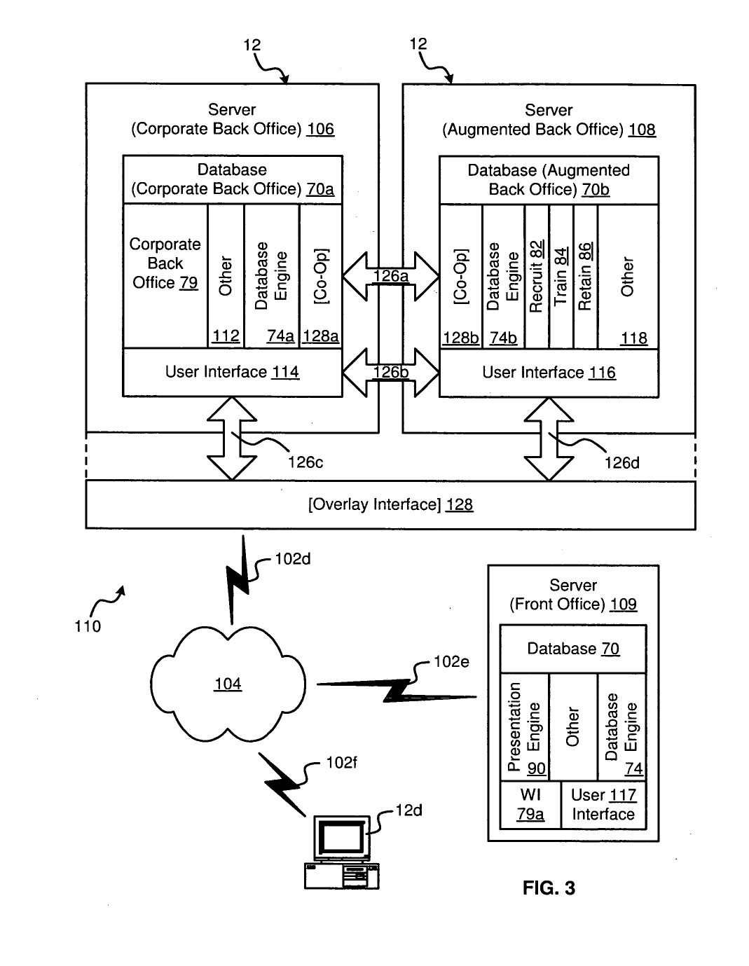

Referring to FIG. 3, in one embodiment of an apparatus and method in accordance with the invention, a server 106 may host a corporate back office database 70a serviced by a database engine 74a. In the illustrated embodiment, the corporate back office module 79 may be hosted on the server 106 along with the database engine 74a. Similarly, a different server, whether hosted on the same platform or not is not critical, since servers may be located side-by-side on the same hardware, or may be on disparate hardware at different locations.

Nevertheless, the server 108, may host the augmented back office database 70b. Accordingly, a database engine 74b may service the database 70b. As an augmented back office server 108 or field office server 108 in accordance with the functions of the field office module 80, the server 108 may host a recruiting module 82, a training module 84, a retention module 86, and the like. Of course, each of the servers 106, 108, or the nodes 12 on which each may be hosted may also host other software applications 112, 118, respectively.

Similarly, each of the servers 106, 108 may provide a user interface 114. Inasmuch as the systems 106, 108 are typically operating over the Internet 104, the applications 79, 112, 74 may be accessed through the user interface 114 over the Internet 104. In order to access the servers 106, 108 together, in accordance with the invention, it is desirable to provide access to both the data in the database 70a and the data in the database 70b to an individual user. In the embodiment of FIG. 2, the single database 70 may contain all of the significant information desired. By contrast, even though the databases 70a, 70b may not necessarily be in the same location, or in the same servers, they may still be accessed together.

For example, typically, the augmented back office server 108 is accessed through the user interface 116. Through that user interface 116, a user may access the database engine 74, and other modules 82, 84, 86 (e.g. executables, applications, or the like) available, as well as any other modules 118. However, in order to provide access to an individual user on a workstation 12d operating over a connection 102f to the Internet 104, a single connection 102d may be advisable. Accordingly, a variety of options exist. Each of the connections 126a, 126b, 126c, and 126d, is optional. Typically, only one of the connections 126a, 126b, 126c, 126d need be used.

In one embodiment, the cooperative modules 128a, 128b may be programmed to operate on the servers 106, 108, respectively. The bracketed names indicate that these executables are optional. In one embodiment, the cooperative modules 128a, 128b may facilitate communication between the database engines 74a, 74b, or between the servers 106 and 108. Thus, by program logic, the servers 106, 108 may communicate with one another when a user on a workstation 12d accesses either the connection 126c or the connection 126d to access either of the servers 106, 108. In this way, in a manner transparent to the user of the workstation 12d, access to both databases 70a, 70b may be made.

Similarly, if the modules 128a, 128b are programmed to operate only with the database engines 74a, 74b, then only the databases 70a, 70b might be accessed between the servers 106, 108. On the other hand, in an alternative embodiment, the cooperative modules 128a, 128b may actually access the entire servers 106, 108, thus providing access to the various other applications 79, 112, 82, 84, 86, 118 and so forth.

In an alternative embodiment, a connection 126b may operate between the user interfaces 114, 116. Thus, if a user accesses either user interface 114 or 116, then that user interface 114, 116, may actually be programmed to access transparently to the user the other user interface 116, 114. In an alternative embodiment, the user interfaces 114, 116 may simply be programmed to transfer control to the other interface 116, 114 upon request, thus toggling between access to the server 106 and the server 108.

In yet another embodiment, connections 126c, 126d to the user interfaces 114, 116 may be programmed to interact with another overlay interface 128. The overlay interface 128 provides a connection to the servers 106, 108 by interfacing either independently from, or through, the interfaces 114, 116. By using the overlay interface 128, an apparatus and method in accordance with the invention may provide access to all of the data in the databases 70a, 70b as well as, optionally, the various applications 79, 112, 82, 84, 86, 118, etc.

As a practical matter, the front office server 109 may be accessed in a similar manner. The front office 109 may be accessed through a user interface 117 directly. Alternatively, the front office server 109 may be accessed through the overlay interface 128 operating through a connection to the user interface 117 just as with the user interfaces 114, 116.

Nevertheless, as a practical matter, the front office server 109 is typically directed to persons not associated with a company. By contrast, the corporate back office server 106 and the augmented back office server 108 or field office server 108 are both directed to persons having a relationship (e.g. distributorship) with the corporate headquarters. Accordingly, the information in both servers 106, 108 is important to their functioning effectively. However, the architecture of FIG. 3 is in a suitable form for retrofitting the functionality of an apparatus and method in accordance with the invention without a massive effort in integrating.

The front office server 109 may be hosted on a node 12 in a system 10 in order to provide access to the database 70 through the user interface 117. Applications for supporting presentations to a web visitor, such as the presentation engine 90, may suitably be hosted on the front office server 109. A suitable web interface 79 may be embodied in any of the servers 106, 108, 109. For example, a user interface 115, 116 may actually be the web interface or incorporate the web interface. Alternatively, the web interface 79 may actually be independent or the like such as the embodiment of the web interface 79a. With each of the web connections 102d, 102e, 102f, an individual user may access the front office server 109 or the Internet 104, while another user on a work station 12d may access the back office server 106, and the augmented back office server 108 or the field office server 108.

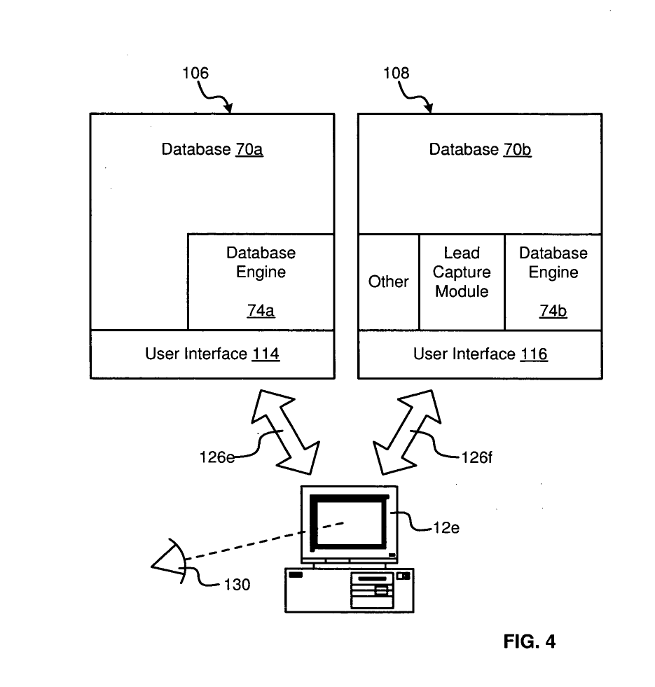

Referring to FIG. 4, a node 12e accessible by a user 130 may rely on a link 126e to access the server 106. Likewise, the user 130 may rely on a link 126f to connect the workstation 12e to a server 108. In the illustrated embodiment, the connections 126e, 126f are substantially independent from one another.

For example, even though each may be an instantiation of the same web link or web browser linked over the Internet to the servers 106, 108, respectively, neither need depend on the other. Thus, one may toggle between the two servers 106, 108 on a single workstation. In this way, the field office workstation 108 may be implemented completely independently from the back office server 106.

For example, the embodiment of FIG. 4 would be suitable in a situation where a corporate headquarters sponsoring the corporate back office server 106 is not interested in incorporating the augmented back office server 108 or field office server 108. Thus, an individual distributor may implement a field office server 108 independently from the server 106, yet still make it available by a mere toggling of different instantiations of the web browser hosted on the workstation 12e.

Accordingly, the front office server 109 when involved in the embodiment of FIG. 4, would be on yet another independent link 102e (see FIG. 3) over the Internet 104 for access to the front office server 109 by a prospect. Typically, the front office server 109 and the embodiment of FIG. 4 would be hosted by a corporate sponsor.

Likewise, the back office server 106 of the corporate sponsor would likewise be available from the same organization. However, an individual distributor may augment these services for the distributors in a downline on the server 108, independently from the corporate headquarters. Thus, the embodiment of FIG. 4 provides an excellent retrofit solution for an independent distributor.

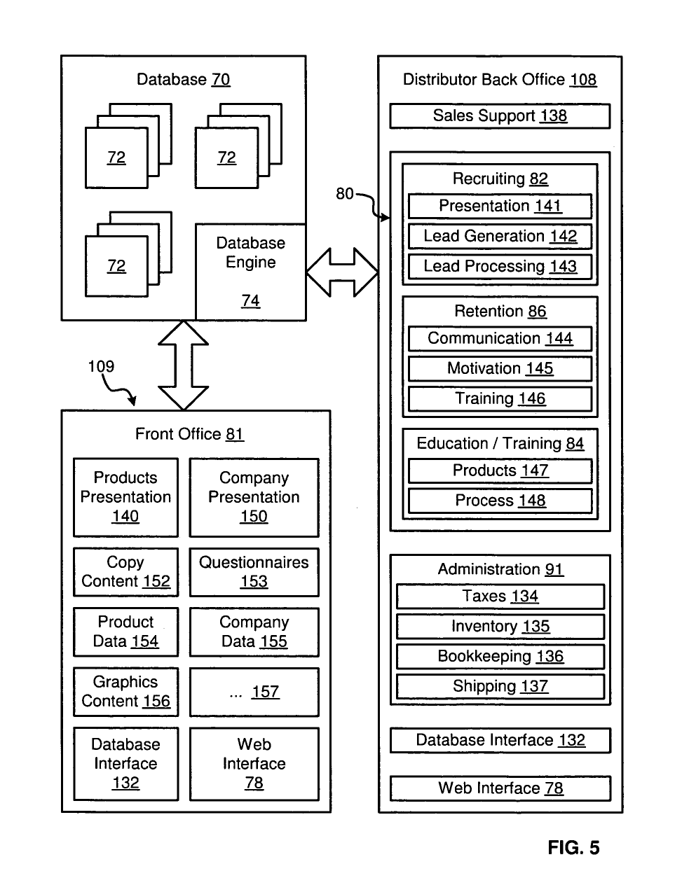

Referring to FIG. 5, in one embodiment of an apparatus and method in accordance with the invention, the database 70 through the database engine 74 may be accessed by a distributor back office server 108. Similarly, a front office server 109 may access the database 70 and its records 72 through the database engine 74. In the embodiment of FIG. 5, the distributor back office server 108 may host a database interface module 132 for accessing the database engine 74 from the server 108. Likewise, a web interface 78 may provide access to the Internet.

Meanwhile, in this embodiment, the database 70 may be hosted on the same server 108 or on a different server. In the illustrated embodiment, each of the servers 108, 109 may have access to the database 70 over the Internet 104, or through a hard connection. In the illustrated embodiment, the distributor back office 108 may provide various administrative functionality.

Typically, the functions of the administration module 91 are hosted by a corporate sponsor. Thus, in the illustrated embodiment, most likely, the distributor back office 108 would be hosted by a corporate sponsor. This is not necessary, but the functions of maintaining a tax module 134 for handling tax issues, an inventory module 135 to manage inventory, a bookkeeping module 136, and a shipping module 137, are functions in modern day network marketing organizations that are typically handled by corporate sponsors.

In historic network marketing organizations, where inventory is managed by individual distributors, the functions of the administration module 91 may be expected to be managed by an individual distributor. Thus, in such an embodiment, the distributor back office server 108 may be hosted entirely by an individual distributor. The administrative module 91 attends to those functions that are conventional and handled by various types of software known as “back office support software” in the software industry. Sometimes back office software and “front office software” or “point-of-purchase” software may be linked together in order to provide a more closely monitored system to manage inventory according to both sales information and order information.

A sales support module 138 may provide sales presentations, information, and other software systems to support a distributor in personal sales. In typical network marketing organizations, individual distributors perform the sales function on their own, and also provide a management function. In the embodiment illustrated in FIG. 5, the sales support module 138 may include any or all of the functionality that would conventionally be required to support sales by an individual distributor. Typically, the sales support module 138 may provide primarily information for use in sales, as opposed to the actual presentations presented by the front office software in the front office server 109, hosting a front office module 81.

In one embodiment of an apparatus and method in accordance with the invention, the front office server 109 may host a front office module 81 providing a presentation module 140. The presentation module 140 is directed to presentation of products. Accordingly, the presentation module 140 presents products to prospects, web visitors to the module 81. The front office module 81 may include either engines, content, or both. Likewise, the front office module 81 and the products presentation module 140 may actually access the content needed in the database 70 and simply maintain engines to access and present the data stored in the database 70. In this way, the product information in the database 70 can be updated in a single location, while the engines to retrieve it and display it may remain more constant.

The back office server 108 or distributor back office server 108 may include a presentation module 141 in the recruiting module 82. The presentation module 141 may provide executables to handle the presentation information provided by the front office products presentation 140, or the company presentation module 150 therein. A lead generation module 142 may take the information collected through the presentation engine 141 in order to generate leads.

The lead generation module 142 may sometimes be thought of as a lead capture module 142. However, together, the concept of a presentation module 142 making a presentation and interacting with a web visitor, a lead generation module 142 collecting and otherwise handing that information, and a lead processing module 143 analyzing data in order to rate the quality or otherwise characterize the lead, may all be considered a part of a lead capture process or a lead capture module.

Regardless of the specific architecture, the functionality of presenting information, collecting data through interactivity and queries such as questionnaires, offers of free products or services in return for responding to questionnaires, and the like may all be suitable for the recruiting module 82 and distributed among the submodules therein. The function of the lead processing module 143 is directed to the value of evaluating the facts actually obtained by a lead generation module 142, in order to process that lead into something that has information and judgment as to how that lead can now be matched with a suitable presenter within the distribution organization.

A retention module 86 may include a communication module 144. The communication module is responsible for providing communications, and may include content, formats, engines to drive the content delivery, as well as scheduling and other processing to assist in communications. For example, in one embodiment, the communications module 144 may include a scheduling module to lay out a particular or standardized series of communications on a schedule. These may pass from or to a particular distributor in accordance with the activities of that distributor and the experience of that distributor. The controlling evaluations may have been made subjectively, objectively, or both regarding what would help that distributor.

Similarly, materials for motivation may include rewards programs, letters of encouragement, and additional tidbits or hints and guidance directed to an individual. These may be selected according to that individual's personal and subjective characteristics, or according to demographic information, standardized evaluation, or statistical information. This may be data such as time in a position, experience in the business, level of training, number of training programs or segments completed, scoring on training, and the like.

Thus, the motivation module 145 may provide information that is directed to an individual by that individual's characteristics. It may be selected in such a way as to provide a statistically significant improvement in performance based on historical evidence objectively analyzed and subjective information of managers responsible.

The training module 146 is not necessarily to replace the education and training module 84, but rather to provide motivational types of training. For example, in certain embodiments, the retention module 86 may include a list of training tips identified as keys to overcoming discouragement, lack of motivation, and the like. The fundamental functions of the retention module 86 are communication and motivation, and these are directed to the functionality of the communications module 144 and the motivation module 145. Nevertheless, training in similar interactions also tends to affect retention.

The education module 84 or training module 84 may include training on various aspects of a business. Typically, a products module 147 will train with respect to information on products. A processes module 148 may focus on processes. For example, processes for selling products, processes for recruiting, systems for reporting, administrative processes, and the like are all necessary to the effective functioning of any individual distributor. Accordingly, the educational module 84 or training module 84 may provide training on products and all the other business processes required from selling, recruiting, and the like to reporting, and organizing one's time.

In one embodiment, the education and training module may also include a testing module. For example, when an individual is trained on a product, then a test to evaluate the quality of the teaching as well as the thoroughness of the learning is in order. The testing module may be incorporated as a part of the particular education module, such as the products module 147 or the processes module 148. Alternatively, or in addition, testing may also be done periodically outside those modules as a means of continuing education and training.

The company presentation module 150 is or may be a sales presentation regarding the company and its operational scheme. For example, compensation, sales support, product offerings, training and management structures, advancement opportunities, and so forth are of interest to many people. Typically, an individual may be most interested in a product and simply be searching for a product heard of by word-of-mouth or through mass advertising. Alternatively, an individual may be looking for a job, alternative sources of income to a regular job, or the like. Accordingly, individuals may come to the front office server 109 over the Internet 104 searching for a product, or a result promised by a product, or may come for work and compensation.

The company presentation module 150 may provide information about the company in any level of detail. Typically, the front office module 81 may include engines to drive the presentations 140, 150. For example, the copy content module 152 may control delivery of the actual copy that will be read. Similarly, the product data module 154 may control the delivery of product data from the database 70 into the proper presentation 140, 150. Similarly, questionnaires 153 may be controlled by a questionnaire module 153. A company data module 155 may control delivery of company data to the presentation modules 140, 150 as needed.

Similarly, a graphic content module 156 may control deliver of graphics. Other modules 157 may control other information delivery to the modules 140,150. Alternatively, the presentations modules 140, 150 may include all the modules 152-157 within themselves. Since the front office server 109 may be accessed independently and individually across the Internet 104, a database interface 132 and a web interface 78 may be appropriate modules to reside within the front office module 81.

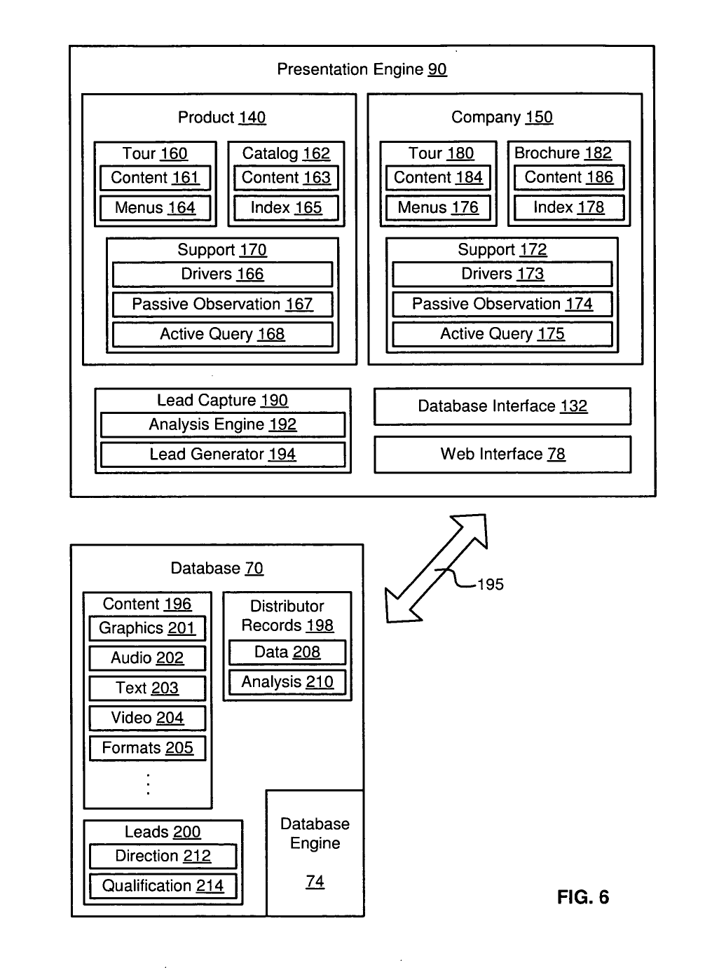

Referring to FIG. 6, one embodiment of a presentation engine module 90 or presentation engine 90 may include a product module 140 and a company module 150. In the illustrated embodiment, the product module 140 may provide alternative mechanisms for accessing information. Some people prefer a guided tour, others prefer to browse on their own. In the illustrated embodiment, a guided tour may present the content 161 of the product module 140 while the catalog module 162 may present the content 163 or content engine 163 in an entirely different navigation format.

The content engines 161, 163 may be configured to operate by menus 164, and indices 165, respectively. Thus, an individual may take a guided tour 160 in a multimedia presentation providing audio, video, images, graphics, interactions, and the like according to a predetermined presentation, and menu selections by a user.

By contrast, although the catalog module 163 may rely on menus as well, they are typically arranged as indices 165. Any individual index 165 may provide access to information, in a fashion that appears organized, easily navigable, and in which information is presented logically and linked together. Thus, an individual having specific questions may prefer a catalog module 162 in order to look at specific information regarding products, or features. By contrast, someone less familiar with a company's product offering may simply be interested in a guided tour provided by the tour module 160.

In the illustrated embodiment, the product module 140 may include suitable drivers 166 for supporting delivery of the content desired. For example, in product sales, an individual computer of a web visitor may not have the drivers necessary to show the multimedia presentation of the tour module 160 or catalog 162. Accordingly, the drivers 166, or a drivers module 166, may need to provide the drivers to a user or drive them from the product module 140 and deliver them as images over the Internet 104 to an individual user.

The passive observation module 166 is one embodiment of a mechanism to acquire information according to the attitudes and browsing of a user. By passive observation is meant the acquisition of information simply according to the progress of a user and the tracking of information available in that manner. For example, tracking a user's URL, geography, or the like, may not be available passively. However, to know that a certain percentage of users select certain products and dwell for selected periods of time on certain products is itself information as to popularity of certain products.

By contrast, an active query module 168 may actually provide information to a user, a question, or both. Thus, when an individual requests to view certain products, or to obtain certain information, a followup query may be necessary in order to make a selection between one type or class of products and another. Accordingly, the active query module 168 may be responsible to pose queries and collect the information therefrom.

Moreover, an active query module 168 may also support questionnaires. For example, a user may be offered a spiff (a gift of service or product) in return for taking the time to respond to a questionnaire. Thus, both a passive observation module 167 and an active query module 168 may be used to collect information that will be useful in better serving a prospective customer or recruit. The modules 166, 167, 168 may be thought of as a support module 170, or support group 170. By contrast, the tour module 160 and the catalog module 162 are the principal reason for existence of the product module 140.

The company module 150 operates, or operates very similarly to, the product module 140. A tour module 180 or company tour module 180 contains a content engine 184 or content 184, depending on the embodiment. A content engine 184 may access through the database interface 132 information in the database 70. Thus, a guided tour 180 may provide menus 176 in order to assist a user in broad selections of preprogrammed presentations and information.

A company catalog is typically not called a catalog but a brochure. Thus, a company brochure module 182 may provide the information regarding the company and its programs in much the same way that a catalog module 163 provides catalog-type information regarding products. Thus, a content engine 186 may control presentation of the company brochure information to someone who would rather use an index 178 or a menu driven index 178 to find information logically according to specific areas of focus.

For example, just as an individual may have a specific need, or a specific product in mind, an individual may have a specific point of interest with respect to a company's programs. For example, someone who has much experience in marketing, and particularly in a network marketing environment, may simply be interested in certain aspects of a benefits program or compensation program. That is, already understanding the mechanisms, and perhaps understanding the product, an individual may wish to consult a brochure module 182 in order to find the specific answers to key questions on which a decision may hang.

The support module 172 may include the drivers module 173, a passive observation module 174, and an active query module 175. These may operate similarly in support of the company module 150, just as the corresponding modules 166, 167, 168, 170 supported the product module 140.

Division of the product module 140 from the company module 150 is a significant benefit. Most people are first interested in products. Those people will most often become customers if not disrupted by a presentation of the company. Moreover, presentations on company benefits programs, rebates, compensation schemes, and the like often lead a purchaser of products to be dismayed at the bragging of a company about the high markups available for salespersons. Thus, presenting company compensation information in the same tour as product information can be counterproductive. Thus, individuals may look at those aspects of the presentation engine 90 of most interest, and not be driven away by information of last or no interest.

In one embodiment, a lead capture module 190 may include an analysis engine 192 and a lead generator 194. The functions of a lead capture module 190 may be distributed in a variety of ways. In certain embodiments, the lead capture module 190 may be implemented by distributed logic throughout various aspects of the front office module 81, and the back office servers 106, or 108. Regardless, logically, an analysis engine 192 may be implemented to analyze the data provided by a web visitor.

The lead capture module 190 may then use the information therein, as well as information from the database 70 regarding the historical and statistical information gleaned from many sales and many visitors to the websites, in order to generate a lead. The lead generator 194 does not simply provide contact information. That is, contact information may be provided, but a lead generator 194 in one embodiment will provide not only contact information of those who may ask for additional information, but a profile of the contact.

Thus, areas of product interest, age, demographic characterizations, business background relative to the products, features, and organization of a company, and the like may all be included in the evaluation of qualification of a lead. The lead generator module 194 may actually provide sufficient information to qualify a lead in enough detail to provide insight into how to approach that lead or contact to greatest effect.

For example, the database 70 may store a variety of records 72. Those records may include, for example, all of the presentation information, including content 196, and distributor records 198. For example, content such as graphics 201, audio files 202, text files 203, video files 204, formats 205, and the like for presentations may all be contained in the database 70.

Likewise, distributor records 198 may include tremendous amounts of data 208. For example, all of the contact information, historical data, sales information, and the like may be stored as data 208. Nevertheless, an analysis module 210 or analysis information 210 may include that same data 208 processed in such a way as to provide more information. Likewise, the analysis 210 may include subjective analysis or subjective information processed with the data 208 in order to provide additional information regarding distributors.

In one embodiment, a lead capture engine 190 or a lead capture module 190 may actually take the distributor records 198 in combination with the contact information from a lead, and send back to the database 70 information for the leads 200, including both direction 212 of the lead, and qualification 214 of the lead. In accordance with the analysis engine 192 operating to generate information and analysis for the lead capture engine 190, and using the analysis data 210 from the distributor record 198, the lead capture module 190 may actually send from the lead generator 194 leads 200 that identify both the direction 212 (e.g. the distributor) and the rationale for selecting that distributor, as well as the detailed qualifications 214 of the lead.

In this way, a lead may be sent automatically to a different distributor from the one hosting the website to which the web visitor initially came. Alternatively, the direction information 212 or the qualification information 214 may simply come by way of suggestion for matching up a lead with the set of qualifications 214 best suited to approach that lead.

For example, an individual who has substantially no product experience, no sales experience, and a young age, is probably not the right contact for a person who has many years in network marketing, has previously represented one or more products for an extensive period of time, and already has knowledge of a market, and of the products in that market in which the products of a particular company fit. That lead is likely to be wasted if approached by an individual with no experience.

Nevertheless, in accordance with an apparatus and method according to the invention, such an individual web visitor may approach any website in the world sponsored by any distributor in the world. Automatic intervention by a computer program, or intervention by a host of a website may evaluate and direct the leads 200. The information for the direction 212 and the qualification 214 may both be provided in the database 70.

In one embodiment, the direction information 212 may actually include a list of the three highest producing and most competent distributors within a reasonable distance of a particular contact. Thus, the host of a website bringing in a contact may be presented with the opportunity to direct that lead to someone in the upline or downline of that distributor.

For example, a very busy distributor may prefer to hand off the lead to someone in the downline. An ability to select somebody of known competence, training, skills, experience, and knowledge will motivate handing that lead off to such a person. Likewise, a very inexperienced person in a downline may prefer to hand that contact up to a supervisor in the upline in order to provide proper skill and handling. By the same token, a very new, young, or inexperienced contact may be passed on by a high level supervisor to anybody in the downline who is looking to build a clientele.

All of the links 195 between the various engines (e.g. presentation engine 90) and the database 70 may be through hard lines on an individual computer, or through the Internet. Thus, in some embodiments, the presentation engine 90 may actually be hosted by a corporate sponsor. Alternatively, the presentation engine 90 may be hosted on the website of an individual distributor. Meanwhile, the database 70 will typically be hosted by a corporate sponsor. Nevertheless, given the nature of network marketing, any of the modules may be hosted on any computer, depending on which particular individual has the authority to make a decision and the interest in making use of the resource.

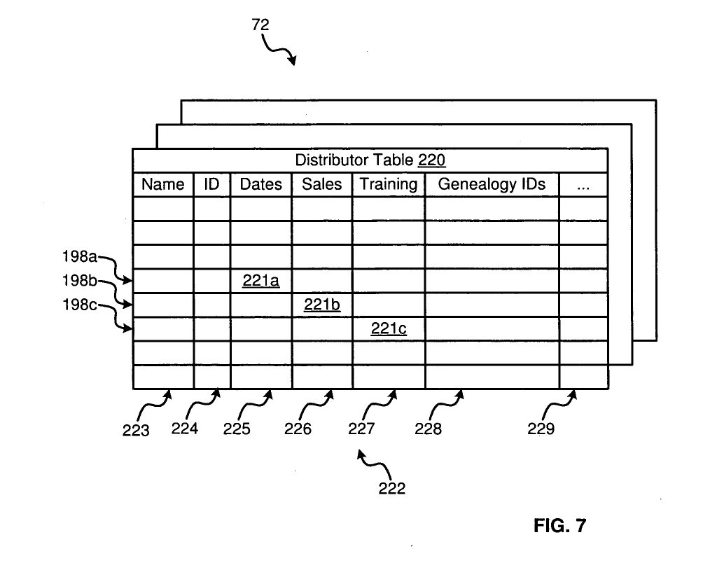

Referring to FIG. 7, database records 72 may be embodied in various formats. In one embodiment, a database record 72 may be embodied as a table 220. For example, a distributor table 220 may include various entries 221 arranged by individual distributor records 198. Each of the records 198 may include entries 221 for each of the fields 222. For example, a field 223 may include name information. By any individual field 222, a particular embodiment may include one or more fields for any particular type of information.

For example, the name information may be included in one or more fields 223. For example, an entire name may be put into a single field 223, or one may use multiple fields 223 for first name, last name, title, salutation, and the like. Similarly, identification information 224 may include an identifier for the database, an identifier for a company, or the like.

Similarly, date information may be included in date fields 225, while sales information would be in sales fields 226, and training information would be in training fields 227. For example, dates of training may be bound to training levels, test scores may be bound to test numbers, sales information may be bound to data information, and analytical information relating sales to training to dates and the like may be included in the table 220 as well.

Typically, genealogy identification information may be in genealogy fields 228 identifying people in an upline relationship and a downline relationship with respect to a particular distributor. Other fields 229 may include any information, consolidation of information, output of analyses of information, and the like.

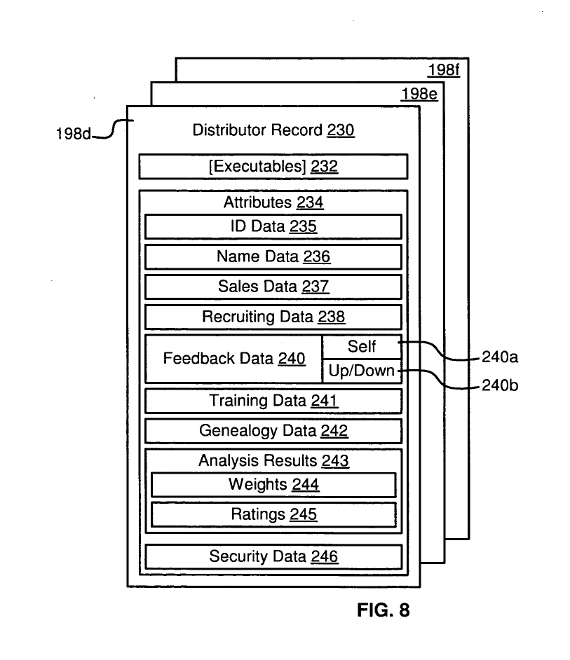

Referring to FIG. 8, a database record 72 may be embodied in various other formats. One format contemplated is an object format in which an object 230 represents a distributor record 230. Accordingly, each individual distributor record 198 may be embodied in a particular object 230. Each object 230 may include executables 232 for processing, inputting, outputting, manipulating, and the like any particular information. Processing of information including presentation and inputs may be completed by optional executables 232 in an object 230. The executables 232 may be imbedded directly within an object 230, or may be embodied in other modules elsewhere.

The actual data stores in a particular distributor record 230 may be in the form of attributes 234. For example, the same information contained in the various fields 222 of a distributor table 220 may be stored in the attributes 234 of the distributor record 230 or distributor object 230. Identification data 235, name data 236, and sales data 237 may be embodied in various formats. Similarly, recruiting data 238 regarding an individual's recruiting situation, or the recruiting done by that individual may be included in recruiting data 238 as various attributes.

Likewise, subjective feedback data may be provided in a feedback attribute 240. Feedback may be objective. For example, sales data 237 is substantially objective data. Likewise, positive and negative or other digital decisions may be objective feedback. Meanwhile, self generated feedback 240a, or peer-review feedback 240b from an upline or a downline may also be included in the feedback data. The feedback data 240 may actually be included in order to assist the lead capture module 190 in making decisions.

For example, a particular rating of a particular distributor may be reduced to a number. An average rating provided by an upline and an average rating provided by a downline may be useful information. Similarly, a rating from customers may be included. Likewise, a weight may be provided. For example, the ratings by downline distributors may be weighted more heavily as to effectiveness in training. Meanwhile, the ratings provided by upline distributors may be weighted more heavily in evaluating sales ability and the like.

Other information that may be included as attributes 234 may include training data 241, including test scores, training levels past, and the dates thereof.

Genealogy data 242 may be included in a conventional format or any other format that would be useful. Typically, genealogy data 242 will include relationship data to link the distributor record 230 or distributor object 230 to other objects 230 corresponding to other distributors.

The records 72 may be better used in a method and apparatus in accordance with the invention if analytical outputs are provided to the distributor records 230. For example, analysis results 243 may include the weights 244 to be given to opinions, abilities, and the data itself. For example, weights 244 may relate to eligibility for performance bonuses, consideration for receiving leads, and the like. For example, if someone is not rated as being a particularly good trainer, they may be given a low weight in terms of their actual experience when being considered by the lead capture module 190 for receiving a lead.

Likewise, ratings 245 may be provided as an analytical tool output. Ratings 245 may be high or low, but those ratings may also have weights 244 associated with them. For example, in sales, upline opinions may matter more. In training, downline opinions may matter more.

Security data 246 providing access may also be included in the attributes 234. By changing various security data 246, an individual distributor record 230 may provide a distributor access to certain website functionality.

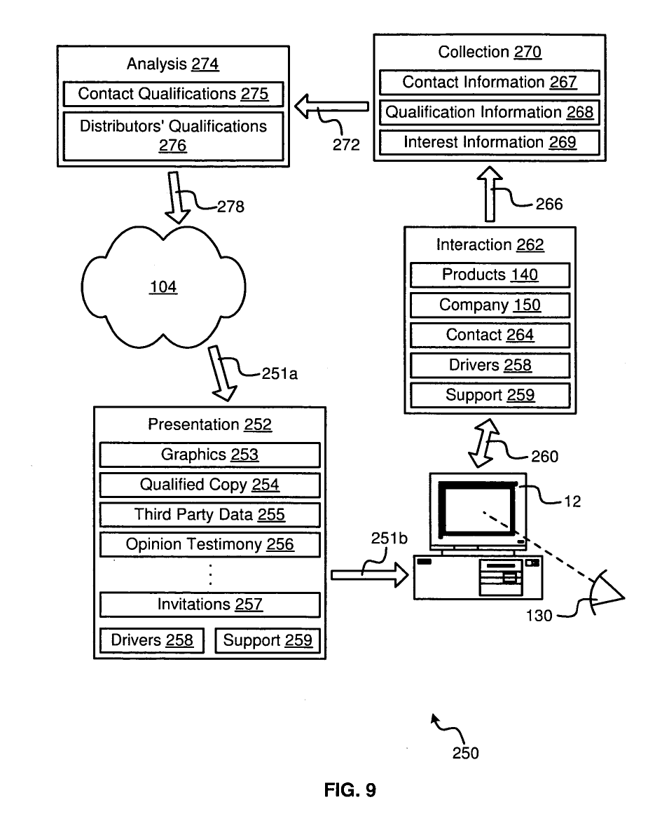

Referring to FIG. 9, a process 250 for implementing a software support system for an Internet-based network marketing system is illustrated. In one embodiment, a delivery 251 a of a presentation module 252 may be made to a node 12 such as workstation 12 of an individual user 130. The presentation 252 may provide graphics 253, qualified copy 254, and the like. Qualified copy 254 is advertising copy that has been proven as to its utility and effectiveness. Similarly, graphics 253 should be typically developed in such a way and tested to be effective. In this way, high quality graphics 253 and highly persuasive advertising copy 254 whether in written format, audio format, or audiovisual combinations, may all be accessible to distributors having a minimum amount of experience.

The presentation module 252 may also include third party data 255. That is, third parties are typically more credible than a particular entity speaking in the first person. Typically, third party data 255 may include research studies by independent parties, blind tests by research organizations, university studies, news articles, and the like reporting facts outside the control of a particular corporate sponsor or distributor sponsoring the presentation module 252. Thus, credibility may be substantially enhanced for the presentation 252 by the inclusion of third party data 255 proving objectively or attesting to a certain efficacy of a product.

Likewise, testimonials may be thought of as opinion testimony 256. That is, individuals may have opinions about companies, products, effectiveness, individual experiences, and the like. Opinion testimony 256 may include anything from a subjective experience with a product, to a personal opinion regarding treatment by an individual. Accordingly, opinion testimony 256 may be included in a presentation module 252 in order that a user 130 may be able to obtain more objective evaluations of information presented.

In one embodiment, a presentation module 252 may include invitations 257. Invitations 257 may be invitations to purchase, invitations to learn more, or other overt presentations of information that will result in more interactivity by a user 130. Typically, an invitation 257 may provide a gift, a promise, pique an interest, or the like, in order to produce a positive response and further engagement by the user 130 in the presentation 252. The invitations may thus solicit more information, by engaging the user 130.

Ultimately, the delivery 251b of the presentation 252 or presentation module 252 to the workstation 12 of a user 130 may result in interactive linking 260 between the server 81, 90, 109 and the workstation 12 of the user 130. Accordingly, an interactive link 260 may provide an interaction module 262 access to the user 130 through the workstation 12. For example, the interaction module 262 may include a products module 140 for presenting information, gathering information, or both.

The company module 150 may provide interactivity. Likewise, a contact module 264 may provide contact information for the company, and gather contact information from the user 130.

The interaction module 262 and the presentation module 252 are not necessarily disparate from one another. The presentation module 252 or the presentation 252 may be thought of as providing information to the workstation 12, while the interaction module 262 or the interactivity of modules 140, 150, 264 as presented in the interaction module 262 may be thought of as the portions of the presentation that provide interactivity and collection of information.

Thus, a link 266 or transfer 266 of information from the interaction module 262 to some collection module 270 may be a principal benefit of the presentation module 252 and the interaction module 262. For example, the collection module 270 may accumulate contact information 267. Until contact information 267 is accumulated, the user 130 is simply an anonymous hit from a visitor to a website.

Similarly, depending on the quality of the information, and the detail thereof, a qualification of a contact may be made using qualification information 268. Qualification information may be any type of information that has been shown to be significant in evaluating the seriousness, level of interest, approach, or the like, for interacting with a user 130.

Likewise, interest information 269 may include the more passive information garnered from passive observation of what items an individual navigated toward. However, the interest information 269 may include responses to overt queries or active queries 168, 175 resulting in responses from the user 130.

A transfer 272 of information from the collection module 270 to the analysis module 274 may result in contact qualifications 275 and distributor's qualifications 276. Contact qualifications may be analytical evaluation outputs resulting from analysis of the contact information 267, qualification information 268, interest information 269, or all of the above, in view of the analytical engines available and the statistical knowledge base from years of evaluating other contacts. Thus, the statistical significance of a particular characteristic of a web visitor may be imputed based on the data from many other similarly situated or similarly qualified contacts.

The distributor's qualifications 276 may include an analytical evaluation based on subjective, objective, or both types of data regarding individual distributors. Typically, one would expect a top sales person or recruiting person to be best situated or most likely to succeed in selling to or recruiting a new contact. Thus, one may choose to rate or weight a particular distributor higher than another. By the same token, matching contact qualifications 275 with distributor qualifications 276 may result in a better output 278 back to the system 10. Again, the embodiment of FIG. 9, when viewed as a process, may be implemented in one of the servers previously discussed within the system 10.

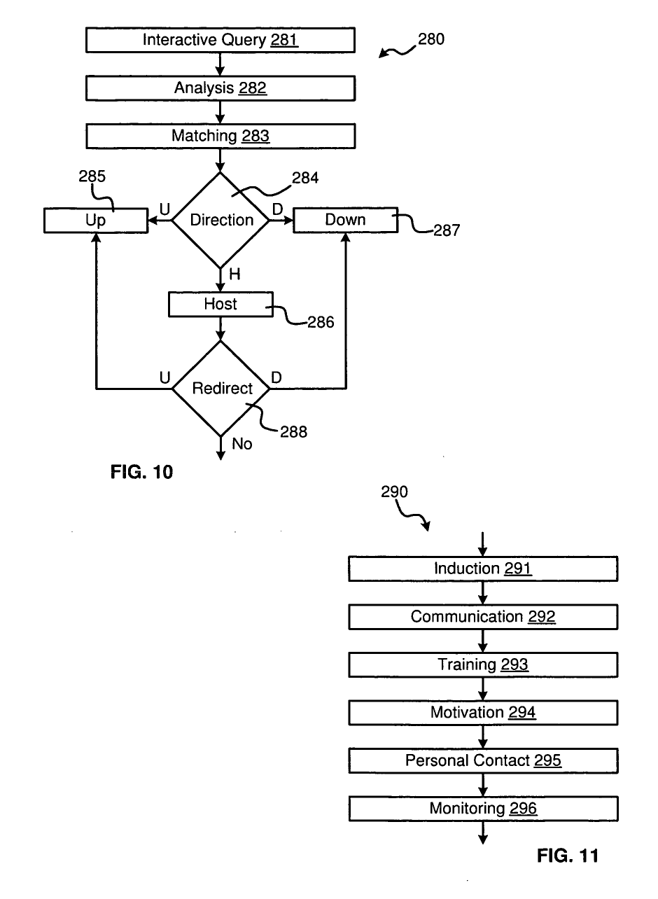

Referring to FIG. 10 a lead management process 280 may include an interactive query module 281. One of the responsibilities of the interactive query module 281 is to pose information in order to obtain interactive responses from a user 130. Questions may be posed and embedded within normal navigation of web pages. Similarly, frequently asked questions may be presented, and thus navigated by a user in order to satisfy an interest.

Likewise, a user may be encouraged to submit a search query or submit a question as a query in order to obtain desired information. Accordingly, the interactive query module 281 may use that information to formulate an analysis or obtain the proper information for an analysis.

In one embodiment, the interactive query module 281 may actually present a questionnaire. The interactive query module 281 may be responsible to motivate the user to address the questionnaire. Thus, in general, an interactive query module 281 may typically be tasked with the responsibility to obtain and motivate interactivity with a user in order to motivate the user to provide useful information.

An analysis module 282 may be responsible to analyze the information provided by the interactive query module 281. In analyzing questions, the analysis module 282 may be responsible to output the qualifications of a particular individual. Weights or rankings with respect to any particular characteristic may be provided as a result of the analysis.

The interactive query module 281 may typically be used on the front office module 81 in order to evaluate contacts. The interactive query 281 may also gather up information regarding distributors. Thus, the analysis engine 282, while suitable for evaluating contact-derived information, may also evaluate distributor information, in certain embodiments.

Typically, in one presently contemplated embodiment, the interactive query module 281 and the analysis module 282 may apply only to the information relative to a web visitor, prospect, or contact. A matching module 283 may match the output of the analysis module 282 regarding characterization or qualification of a prospect with the qualifications of a distributor. Various rankings of various characteristics or opinions of a distributor along with other weights based on other characteristics of a distributor may be used to recommend a match. For example, rankings may come from various persons, but the significance of those persons may be weighted to give more reliable evaluators, more credibility, or more influence in evaluating that distributor.

A test 284 may be undertaken or obviated. In one embodiment, a direction module may make the decision 284 by evaluating the match, and absolutely sending it either up the distribution line to an upline distributor 285, or sending it to a downline distributor 287. Alternatively, the direction decision 284 may actually be made by a human being. For example, the distributor hosting a particular website has obtained the lead by the existence of that website.

An argument can be made that the lead belongs to the host of the website. Nevertheless, by contract, by design, by choice, by agreement, or the like, the direction decision 284 may be made automatically by a computer, automatically by a human being, or by another mechanism. In one embodiment, the host 286 may actually preset the bases of the decisions made by the direction module 284, such that leads are automatically forwarded elsewhere.

For example, a distributor who is overly busy, may find that leads of a certain quality may be best handled by people in his or her downline. Thus, leads of a certain weight, or rating, may be automatically directed by the direction module 284 or the direction decision 284 to a high-producing, downward distributor 287. The down module 287 may be thought of as the person at the selection point in the downline, or the computer thereof. Similarly, the up module 285 may be thought of as the individual in the upline, or the computer thereof receiving the information through the database, contact emails, or the like.

In certain circumstances, a host 286 may preset all direction 284 to the host 286. Accordingly, the host may then individually review the output of the matching module 283, and determine whether to redirect 288. Redirection 288 may be up to a person in the upline 285, or down to a person in the downline 287. In one choice, a host 286 may elect not to redirect to anyone other than himself or herself.

Referring to FIG. 11, a distributor development process 290 may occur with a variety of operations, each of which may occur in series, or in parallel, with others. Likewise, as with most operations in life, they tend to be iterative. One receives a piece of one type of activity, followed by a piece of another type of activity, followed by a piece of yet a third type of activity. Later, one then repeats additional activities, new activities, or the same activities from the first type, the second type, and third type. Thus, the process 290 need not be limited strictly to a serial application of the principles.

For example, in one embodiment, induction 291 may include the initial introduction of a new recruit to a company and its products. The typical information used to welcome a new purchaser or a new recruit in a distributor network may include routine administrative information. Likewise, certain management choices may also be made in accordance with the desires of the supervising distributor, as well as the other new recruit or purchaser. In certain embodiments, choices of activities may be divided between products, marketing, and the like.

Typically, in an induction situation, a distributor will provide basic tools, information, and the like. As part of the induction process 291, a replicated website may be provided. On the other hand, that replicated website may be provided during or after later training in the proper care and feeding of such a tool.

The communication process 292 or communication step 292 may involve engagement of the trainee or new recruit in establishing a communication protocol, communication hardware, or both, and initiating a series of communications in order to administer the business, train in sales, train in recruiting skills, and the like. Typically, communications may be to the upline reporting or by way of requests, and communicating to a downline by way of assisting, responding, and sharing. The communication process 292 is best implemented both up and down within an organizational structure.

Training 293 may include training in factual information, as well as skill information in the ability to sell product and to sell the company. Accordingly, the training module 293 or training step 293 may involve training in any and all aspects of the network marketing business corresponding to the sponsoring organization and the distributor responsible for training a particular recruit.

Motivation 294 may include any and all the techniques and information that may be useful and motivating a distributor. Likewise, live management may be incorporated through a personal contacts process 295 or step 295. In certain embodiments, schedules, materials, content, presentation engines, and the like for implementing communication 292, training 293, and motivation 294 may be prescribed and made available to each recruit.

Accordingly, a normalization or standardization of the quality, content, presentation skills, and the like may be implemented in the communication 292, training 293, and motivation 294 portions of the process 290. Likewise, each may occur in parallel or series with the others, and may be interleaved and repeated recursively or iteratively in order to advance communications 292 on an ongoing basis, continue training 293 on an ongoing basis, and provide motivation 294 on an ongoing an timely basis.

Personal contact 295 may be made in a variety of ways. Individual distributors within a level or two of one another may actually contact one another by phone and in person periodically. Nevertheless, in an apparatus and method in accordance with the invention, a website may recruit customers or distributors from states, nations, or continents far away from one another. Conference calls, and webcasts by a distributor may provide information by way of communication 292, training 293, or motivation 294 to individual recruits in the downline. Similarly, presubmitted questions may be sorted, responses prepared, and presentations made directed to the issues raised.

Accordingly, the personal contact 295 may be distributed from one to many individuals by a supervising distributor. Thus, much of the work that would normally be spent in working with an individual face-to-face may be multiplied and presented to many individuals over the Internet, each of which is similarly situated or otherwise capable of making use of the information.

Monitoring 296 may be implemented with both subjective data and objective feedback returning back through an upline. Similarly, downline inputs regarding a supervisor's effectiveness may also be included in monitoring 296. Thus, testing, tracking, rating, and the like may all be provided for each individual in performing his or her function.

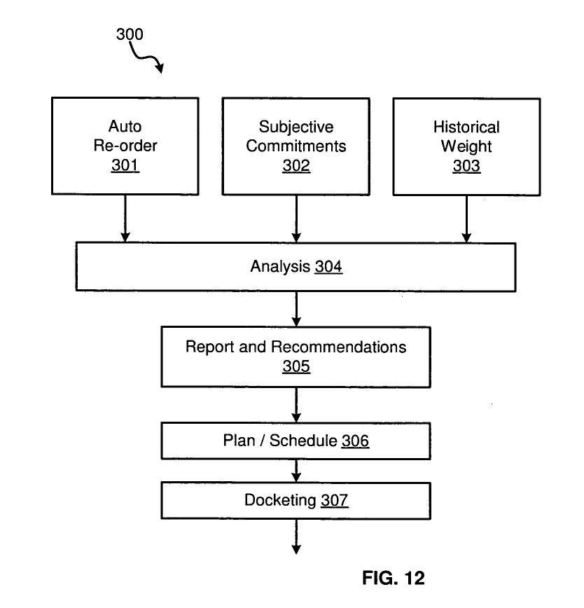

Referring to FIG. 12, a volume management process 300 may be implemented in one of several possible embodiments of an apparatus and method in accordance with the invention. The benefits of the system 10 may provide any and all information from a database 70 from a corporate back office to the field office to the front office in a manner unparalleled. For example, typically, in a network marketing situation, information is transferred into an upline after the fact. Accordingly, a supervisor, absent substantial early efforts and constant, personal communication 292, training 293, and motivation 294, may not know and may not be able to influence the performance of a particular distributor in a downline.

However, much information should be historically available. Accordingly, automatic reorders from regular customers are well known. Likewise, a distributor, through communications with the supervisor will typically make subjective commitments. Likewise, every distributor has a history.

Thus, a volume management process may take automatic reordering information 301 because that information reflects orders that have been made in advance that will be made repeatedly, and a certain fraction of which will be repeated every month or on some other schedule. Likewise, in conference with a supervising distributor, an individual will make subjective commitments as to how much time will be spent, or is available. Likewise, an individual may present a supervisor with plans. Similarly, a known number of leads will be known to exist by a user, or may appear through the lead capture module 190.

Moreover, the historical weight 303 of each piece of information may also be known. For example, the individual may promise to spend a certain amount of time and achieve a certain goal. However, that person has a history. Accordingly, the historical weight 303 (e.g. probability, percent certainty, effectiveness, etc.) of any commitment made may be known and applied. Accordingly, one may discount or put a premium on any subjective commitments 302 made by an individual. The historical weight may also go to several other factors.

Objective data on sales and time spent is known. Accordingly, one may expect that someone who performs at a consistent level will perform at that consistent level month after month. Someone who is inconsistent, may have a high probability of failing to meet any particular level. Nevertheless, over time, even inconsistent performance may have a certain average value. Likewise, subjective evaluations from upline supervisors and downline distributors may also be weighted according to their ratings and the reliability thereof.

Thus, auto reordering information 301, subjective commitment 302, and the historical weights and historical performance factors may be provided as historical information 303. All of that information 301, 302, 303 may be put into an analysis 304 in order to provide a report and recommendations 305. Analysis may include any number of factors from age in life to age in an organization, experience, history in this company, history in other companies, subjective choices and the like.

Thus, based on the analysis 304, a report and recommendations may be made. The report may include information such as a projected performance of an individual. The recommendations may provide recommendations for suitable training, suitable communications, suitable motivational materials, and suitable activities that a supervisor may engage in, in order to help an individual improve or meet objectives. Thus, rather than passively waiting until after the fact to know how someone is going to perform, the supervising distributor may actually be able to directly affect results.

Typically, a supervisor engages in many activities, hoping that they will make a difference. Over time, experience gives some people the knowledge to predict or estimate or otherwise rely on their own judgment as to what will work and how well it will work. In a method and apparatus in accordance with the invention, statistical analysis on individuals and organizations and demographics and other characteristics of individuals can assist in targeting individuals with communications, training, and motivation selected for their particular demographic in the organization as well as their own individual characteristics. Thus, the report and recommendations 305 may be extremely useful and totally unique to an individual.

In certain embodiments of an apparatus and method in accordance with invention, a plan, schedule, or both may be put together in an output for a user. All of the steps in the process 300 may be performed by computers. Likewise, human intervention may be undertaken by inputting information into the database records 72. Thus, a plan and schedule may include, for example, a chart providing all of the individuals in a supervisor's downline, appropriate communications, training, and motivation for those individuals, and a schedule for sending or engaging those communications steps 292, training steps 293, and motivational steps 294 directed to that individual. Finally, since the actions are or can be made quite specific according to the plan or plan and schedule 300, docketing 307 may occur to actually initiate, execute, and follow up on each of the actions planned.

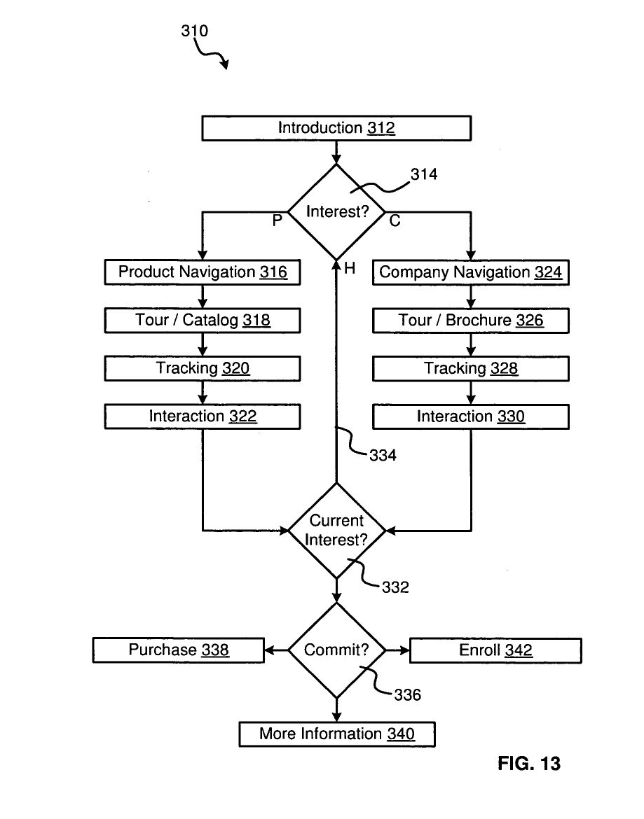

Referring to FIG. 13, a process 310 for lead generation or lead management may begin with an introduction 312. The introduction may provide some assistance in navigating a website, some information to pique curiosity, some spiff to motivate to action, or the like. A visitor to a website always has access to an exit button and a back button (e.g. in a browser). Thus, a visitor may exit this process 310 at any time. One never need be caught in an infinite “DO-loop” with no way out. Typically, an introduction 312 will include a short tutorial even if only a single instruction or presentation of a single button allowing the web visitor to move forward through a presentation and navigate the web pages.

Typically, a test 314 may affirmatively determine the visitors interest. Typically most visitors to a website are interested in the product. They have heard by word of mouth, from a friend, through advertising, or otherwise, of a product, or are searching by feature for a product that contains a feature. Thus, typically the interest decision 314 may be directed to a product or to the company. Typically, a product navigation step 316 will allow the person to choose, through an index or the like, whether they will be undertaking a tour or a catalog 318. Thus, the tour or catalog step 318 will permit the web visitor to see the tour described above, or to peruse or browse a catalog 318. Typically, tracking 320 will occur, and interaction 322 according to the engines described hereinabove. Ultimately, a web visitor has thereby obtained information, and has come to some degree of interest.

On the other hand, if an individual at the test 314 selects an interest corresponding to the company, then a company navigation step 324, such as access to an index, matrix, or other navigational aid, may permit persons to direct themselves to a tour 326A or brochure 326B. Similar to the treatment with a product, tracking 328 may occur and interaction 330 will be motivated, encouraged, and undertaken. Ultimately, by either path, an individual will either exit the website or develop some degree of interest.

Accordingly, a test 332 may provide the person an overt or subtle invitation to express an interest. That is, in one embodiment of an apparatus and method in accordance with the invention, product information and company information may be absolutely divided and never presented together. Alternatively, a test 332 may permit a person having viewed one tour 318a, 326a to choose to view the other tour 326a, 318a. Likewise, one who has viewed a catalog 318b or brochure 326b, may elect to view a brochure 326b or a catalog 318b, based on the previous experience.

In certain embodiments, the test 314 as to interest may be made initially, and not repeated unless some other overt or subtle indication is made by the web visitor. The separation of product and company can be extremely important in a user's perceptions and decision to remain involved with the website. Thus, prior art systems are not known to the inventors to produce this dichotomy in such a way as to maintain interest by not “turning off” a visitor by presenting inappropriate information pushing something in which the visitor is not interested.

For example, people who are involved in network marketing, are often dedicated to products. Nevertheless, others involved in network marketing are dedicated to the job and their own performance. Accordingly, somebody dedicated to a product may be less interested in company structure. Somebody who is dedicated to the company compensation plan and programs, may take the product as a given, assume or know from other information that the product is fine, and be interested only in learning about the company. The test 332 may subtly or overtly permit a user to cycle back through the test 314 and evaluate their interest in the other branch of the process 310.

Ultimately, a user will come to the test 336 directed to commitment. For example, if a person accesses a website and looks at products, then purchase 338 is the logical conclusion. If a person is more interested in the company and the recruiting and distributorship program, then enrollment 342 or enrolling 342 may be the result. People who are indecisive, or who have perhaps purchased 338 may determine that they need more information 340. Accordingly, a request for more information 340 may typically lead to a questionnaire, and development of a contact. Those who ask for more information 340 would be prime candidates to be developed by the lead capture engine 190 and followed up with by someone in the distributorship organization.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed and desired to be secured by a United States Letter Patent is:

1. An apparatus comprising:
a server hosting a back office module providing at least one of administration, volumes management, genealogies management, reporting, commissions, and order processing corresponding to a product and distributors of the product in a network marketing organization;
a field office module providing recruiting support, training support, retention support, website replication support; and
a front office module comprising a presentation module containing a product presentation module, a company presentation module, and a lead capture module.

2. The apparatus of claim 1 further comprising a presentation engine presenting information to a web visitor.

3. The apparatus of claim 2 further comprising a web interface module connecting the apparatus to the Internet.

4. The apparatus of claim 3 further comprising a database storing information relating to sales.

5. The apparatus of claim 4 further comprising a database engine accessing the database.

6. The apparatus of claim 5 further comprising a replication module providing automatically to a recruit a replication of at least one of the field office module and front office module.

7. An apparatus comprising:
a front office server providing a presentation of product information, company information, and a lead capture module for a network marketing organization;
a back office server providing an administration module, a volumes module, a genealogies module, a reporting module, and a commissions module processing information corresponding to the network marketing organization; and
a field office server comprising a recruiting module, a training module, and a retention module accessible by a person in the network marketing organization.

8. The apparatus of claim 7, wherein the back office module further comprises an order processing module.

9. The apparatus of claim 8, further comprising a replication module in the field office server replicating websites to recruited distributors.

10. The apparatus of claim 9, further comprising a presentation engine presenting at least one of recruiting, training, and retention to a recruited distributor.

11. The apparatus of claim 10, wherein the retention module further comprises a communication module and a motivation module.

12. A method to recruit, the method comprising:
providing a computer system;
connecting the computer system to the Internet;
loading software for executing selected steps in accordance with the method on the computer over the Internet;
executing an introduction to a user over the Internet;
testing interest of the user between a product and a company program;
producing a decision of the user based on the testing; and
presentation of a tour of content corresponding to and based upon the decision.

13. The apparatus of claim 12 wherein the content is selected from product information, product advertising copy, company structure, and a company compensation plan.

14. The method of claim 13, further comprising:
tracking visitor interactions with the tour;
interacting with the visitor to provide information corresponding to the visitor's interest in the content;
evaluating commitment of the visitor to act in response to the content.

15. The method of claim 14, further comprising selecting one of a purchase, an enrollment, and a request for information.

16. The method of claim 15, further comprising:
following up on the request for information to generate a lead;
automatically directing the lead to a distributor, by the computer system, based upon criteria ranking effectiveness of the distributor; and
contacting the lead to provide additional information.

17. The method of claim 12, further comprising:
hosting on a computer system a database;
providing Internet access to a sales associate;
providing automatic reorder information corresponding to the sales associate;
providing from a database commitments from the sales person, sales associate;
providing weightings for the commitments of the sales associate;
providing history comprising objective and subjective facts; and
weighting commitments with historical weights derived from the historical facts.

18. The method of claim 17, further comprising:
analyzing in a method or, the sales probability of automatic reorders;
analyzing in a method or the probabilities of subjective commitments; and
outputting a projected sales value based on automatic reorders and subjective commitments, based on historical weights and analysis thereof.

19. The method of claim 18, further comprising:
providing a report;
providing recommendations for actions by a supervisor of the sales associate; and
providing by the computer an automated plan development for training, activities, communication, and motivation to be directed by a supervisor to the sale associate.

20. The method of claim 19, further comprising:
docketing by the computer the initiation and execution of the activities contained within the plan; and
delivering by the computer system over the Internet, the planned training materials, communication materials, and motivation materials to the sales associate.
